(19) United States
(12) Patent Application Publication
(10) Pub. No.: US 2024/0224834 A9
(43) Pub. Date: Jul. 11, 2024

(54) AUTONOMOUS AGRICULTURAL ROBOT

(71) Applicant: NAÏO-TECHNOLOGIES, ESCALQUENS (FR)

(72) Inventors: Joan ANDREU, AIROUX (FR); Franck JUNG, MONTLAUR (FR); Denis MOINDRAULT, MAUREMONT (FR); Bruno MATHIEU, CASTANET (FR); Cédric SEGUINEAU, AUTERIVE (FR)

(21) Appl. No.: 18/547,005

(22) PCT Filed: Feb. 22, 2022
(86) PCT No.: PCT/EP2022/054323

§ 371 Date: Aug. 18, 2023

(30) Foreign Application Priority Data
Feb. 22, 2021 (FR) 2101693

(51) Int. Cl. A01B 69/04; A01B 39/16; B60W 60/00

(52) U.S. Cl. CPC A01B 69/008; A01B 39/16; B60W 60/0011; B60W 2300/15

(57) ABSTRACT

An autonomous agricultural robot, referred to as robot, including: a straddle chassis defining an aisle through which a row of crops can pass, propulsion means for moving the robot in a direction of forward travel, a control unit for controlling the robot and an obstacle-characterization device. This device including: obstacle detection means which are configured to detect an obstacle lying in the path of the autonomous agricultural robot, a processing unit configured so that when an obstacle is detected by the obstacle-detection means, the unit logs the data collected by the obstacle-detection means, and/or processes the data collected by the obstacle-detection means and determines at least one characteristic of the detected obstacle.

### CROSS REFERENCE TO RELATED APPLICATIONS

This application is a National Stage of International Application No. PCT/EP2022/054323, having an International Filing Date of 22 Feb. 2022, which designated the United States of America, and which International Application was published under PCT Article 21(2) as WO Publication No. 2022/175540 A1, which claims priority from and the benefit of French Patent Application No. 2101693 filed on 22 Feb. 2021, the disclosures of which are incorporated herein by reference in their entireties.

### BACKGROUND

### Field

The present disclosure relates to the agriculture field, and in particular to autonomous agricultural machines. More particularly, it relates to autonomous agricultural robots including an obstacle characterisation device, a safeguarding method and a method for producing a cartography of an associated crop parcel.

For example, the disclosure is intended for agricultural equipment having automated or autonomous functions, dedicated to agriculture, in particular to row cropping, such as vines.

### Brief Description of Related Developments

Agricultural crops, especially row crops, such as vines, require regular maintenance. The maintenance of these crops includes various operations such as weeding, hoeing, debudding, or trimming. The maintenance of these agricultural crops is more and more carried out by automated agricultural robots, generally equipped with specific maintenance tools (removable or not). However, to date, these automated agricultural robots still require the permanent presence of an operator, who supervises these maintenance operations. Indeed, the environment in which these maintenance operations are carried out is outdoor and open. Therefore, when the automated agricultural robot moves between the rows of vines, unexpected obstacles, whether other elements of the environment or the presence of agricultural workers nearby, may cross its trajectory.

Thus, currently, when an unpredictable obstacle crosses the trajectory of the automated agricultural robot, the operator makes it stop, manually removes the obstacle and restarts it.

Nevertheless, this solution is not satisfactory since it requires human intervention throughout the entire duration of the maintenance operation, which generates additional costs and does not correspond to what is expected of a so-called autonomous robot.

A solution based on image analysis or data fusion technologies from 2D or 3D vision systems to distinguish potential obstacles may be considered. Nonetheless, this solution would prove to be too complex to master in all the environmental configurations of application in the agricultural field. Indeed, the obstacles are very different from each other, and the environment in which the robot using these technologies would evolve is open.

Besides, some obstacles may be hidden, for example by leaves, and therefore undetectable by a 2D or 3D vision system. In addition, these technologies do not protect against the apparition of false obstacle detection, for example a simple tuft of grass could be perceived as an obstacle.

Another solution based on heat detection, in particular in order to detect a human being, may also be considered. However, this solution would prove to be unusable during the high heat of summer, when the temperature of the elements of the environment would approach the body temperature of a human being.

Currently, no solution allows carrying out common agricultural operations in a complex environment in a completely automated and autonomous way, because there is no sufficiently robust, reliable and efficient solution to characterise the encountered obstacles.

At the same time, the cartography of a crop parcel is an essential operation in order to accurately locate the location of the vines, for example. Afterwards, this cartography is transmitted to the autonomous agricultural robot so that it proceeds with the treatment of the vines in an accurate manner. Currently, there are solutions based on image processing technologies from drones, equipped with multispectral sensors. These sensors measure the radiation of the vines in the near-infrared range to estimate the photosynthesis quality. Nevertheless, these technologies are very expensive because they require advanced equipment and very complex image processing. Currently, there is also no solution to produce a sufficiently robust, simple and efficient cartography of a row crop.

### SUMMARY

The present disclosure aims to overcome the drawbacks of the prior art set out hereinbefore, by providing a simple solution, allowing characterising the obstacles for an autonomous agricultural robot. In addition, the present disclosure aims to provide a method for safeguarding said autonomous agricultural robot so that it could stop autonomously so as not to damage or be damaged by an obstacle in its trajectory. Also, the present disclosure aims to provide a reliable, robust cartography solution, based on a mechanical device.

To this end, an object of the present disclosure is an autonomous agricultural robot, called a robot, including a straddle frame defining a passageway for a row of crops, means for propelling the robot according to a direction of forward travel, a control unit of the robot, said robot including an obstacle characterisation device comprising obstacle detection means configured to detect an obstacle located on a trajectory of the robot, a processing unit configured, when an obstacle is detected by the obstacle detection means, to record the data collected by said obstacle detection means, and/or processing the data collected by said obstacle detection means and determining at least one characteristic of the detected obstacle.

In particular aspects, the disclosure also embeds the following features, implemented separately or in each of their technically feasible combinations.

In one aspect, the at least one characteristic of the detected obstacle is selected from among a position of the detected obstacle with respect to a reference frame of the robot or an apparent dimension of the detected obstacle. Thus, the robot is then able to characterise the detected obstacle, either by its location and/or its apparent dimension.

In a particularly advantageous configuration, the processing unit of the robot is configured to verify whether the at least one characteristic meets a predefined criterion. Thus, the robot is able to make a classification between the obstacles, depending on whether the at least one characteristic meets the predefined criterion.

Without limitation, this criterion may be a list of locations, or a maximum apparent dimension.

According to a particular aspect, the obstacle detection means of the robot include two arms, movable and arranged respectively on either side of a longitudinal midplane of the passageway, and two sensors, one sensor per arm, each sensor being configured to detect a change in the position of the associated arm. This aspect has the advantage of mechanically detecting at least one characteristic of the obstacle.

When no pressure is exerted on both arms, it is said that said two arms are in the rest position. Advantageously, the obstacle characterisation device comprises a return system of the two arms configured to return said two arms to the rest position when the force that moved said arms to an intermediate position is suppressed. Advantageously, said return system allows enhancing the autonomy of the device by ensuring closure thereof in an autonomous manner. Advantageously, the two arms of the robot are movable in rotation, according to an axis parallel to the longitudinal midplane of the passageway and the two sensors are angular sensors. Advantageously, this aspect allows detecting at least one characteristic of the obstacle in a robust manner.

In a particularly advantageous aspect, when the two arms are in the so-called rest position, said two arms are arranged in the same plane transverse to the direction of forward travel. Said arms comprise first and second arms, the first arm comprising a first end and an opposite second end, the second arm comprising a first end and an opposite second end, said second ends of each arm being positioned opposite one another.

This aspect has the advantage of covering the entire width of the passageway, and therefore of being able to detect the obstacles located on said passageway. In addition, it allows limiting the size of the obstacle characterisation device.

In a particularly advantageous configuration, said two arms are in the form of a longitudinal bar, and, when the arms are in the rest position, each arm has:
a length (L) according to a longitudinal axis parallel to the direction of forward travel of the robot,
a height (H) according to a vertical axis, perpendicular to the longitudinal axis and to a transverse axis, itself perpendicular to the longitudinal axis, and oriented in a horizontal direction when the propulsion means of the robot are in contact with the ground,
each arm having over a length (L1) from the second end a reduced height (H1), such that, in the rest position, the reduced-height portions of each arm are superimposed on top of one another.

This aspect has the advantage of characterising the obstacles that are not comprised substantially in the longitudinal plane of the passageway in a more accurate manner compared to a configuration of the obstacle characterisation device having arms comprising no reduced-height portions superimposed on top of one another.

In another aspect, the two arms are movable in translation, in a plane perpendicular to the longitudinal midplane of the passageway, the two sensors are linear displacement sensors.

Advantageously, in these last two aspects, the at least one characteristic of the detected obstacle may also be the sum of the angles of the two arms or the sum of the movements of the two arms. This advantageous configuration allows limiting the calculations within the processing unit, and therefore accelerating the determination of the characteristic of the obstacle and whether it meets the predefined criterion.

The present disclosure also relates to a method for safeguarding a robot including, when an obstacle is detected by the obstacle detection means, the steps of:
Obtaining the data collected by the obstacle detection means,
Processing the data and determining at least one characteristic of the detected obstacle, by the processing unit,
Verifying, by the processing unit, whether the at least one characteristic of the detected obstacle meets the predefined criterion,
Transmitting, to the control unit of the robot, an instruction to stop the robot when the at least one characteristic does not meet the predefined criterion.

In particular aspects, the disclosure also embeds the following features, implemented separately or in each of their technically feasible combinations

According to a particularly advantageous aspect of the method for safeguarding the robot, when the at least one characteristic is the apparent dimension of the detected obstacle, the processing step includes the calculation of the apparent dimension of the detected obstacle, the predefined criterion being met when the calculated apparent dimension does not exceed a predefined value. Thus, this mode of implementation allows making the robot stop for obstacles whose apparent dimension is larger than the predefined value. This predefined value may be the maximum diameter of a vine stock in the non-limiting context of use of the robot in a vineyard. Thus, the robot stops only for obstacles with an apparent dimension larger than that of a vine stock.

In one mode of implementation of the method for safeguarding the robot, when the at least one characteristic is the position of the detected obstacle, the processing step includes the calculation of the position of the obstacle, the predefined criterion being met when the position of the calculated obstacle does not exceed a predefined value.

According to an aspect of the method for safeguarding the robot, when the at least one characteristic is the sum of the angles of the two arms or the sum of the displacements of the two arms, the processing step includes the calculation of the sum of the angles of the two arms or the sum of the movements of the two arms, the predefined criterion being met when the calculated sum of the angles of the two arms or the calculated sum of the displacements of the two arms does not exceed a predefined value. This mode of implementation also allows characterising the obstacles and making the robot stop for the obstacles that cause a separation of the arms of the obstacle detection device greater than the predefined value. Advantageously, it allows limiting the calculations and obtaining a faster characterisation.

The present disclosure also relates to a method for producing a cartography of a crop parcel for the robot including a navigation system, said method including, when an obstacle is detected by the obstacle detection means, the steps of:
Obtaining the data collected by said obstacle detection means,
Collecting the location of the autonomous agricultural robot by the navigation system,
Recording a “data collected by said obstacle detection means—location of the autonomous agricultural robot” doublet.

Advantageously, the method for producing a cartography of a crop parcel may consist of a cartography step prior to the safeguarding method.

In a preferred aspect of the method for producing a cartography of a crop parcel for the robot including a navigation system, said method includes, when an obstacle is detected by the obstacle detection means, the steps of:
Obtaining the data collected by said obstacle detection means,
Collecting the location of the autonomous agricultural robot by the navigation system,
Processing the data collected by the obstacle detection means and determining at least one characteristic of the detected obstacle
Recording a “the at least one characteristic of the detected obstacle—location of the autonomous agricultural robot” doublet.

Advantageously, this mode of implementation of the method for producing a cartography of a crop parcel may consist of a cartography step prior to the safeguarding method without requiring external processing of the obtained data.

In a particularly advantageous mode of implementation of the safeguarding method, the latter includes a prior step of producing a georeferenced cartography of a crop parcel with a location of the acceptable obstacles. Thus, this prior step of producing a georeferenced cartography of a crop parcel with a location of the acceptable obstacles allows distinguishing between the acceptable obstacles and the unacceptable obstacles, and making the robot stop only in the event of detection of an unacceptable obstacle.

According to a particularly advantageous mode of implementation of the method for safeguarding the robot, the step of transmitting an instruction to stop the robot is conditional on the additional verification that the detected obstacle is not one of the acceptable obstacles.

Advantageously, this mode of implementation allows limiting false positives, i.e. the stops of the robot that are not due to a disturbing obstacle located in the trajectory of said robot.

### BRIEF DESCRIPTION OF THE FIGURES

The disclosure will be better understood upon reading the following description, given as a non-limiting example, and made with reference to the figures which show:

FIG. 1 is a schematic front view of an autonomous agricultural robot equipped with obstacle detection means according to a first aspect;

FIG. 2 is an enlarged view of the obstacle detection means illustrated in FIG. 1.

In the figures, the different elements are showed schematically and are not necessarily to the same scale. In all figures, identical or equivalent elements bear the same reference numeral.

### DETAILED DESCRIPTION

The present disclosure primarily relates to an autonomous agricultural robot. The disclosure is described in the particular context of one of its preferred fields of application in which the autonomous agricultural robot is intended for use in vineyard parcels. However, nothing excludes the use of the autonomous agricultural robot for any other type of row crops or plantations.

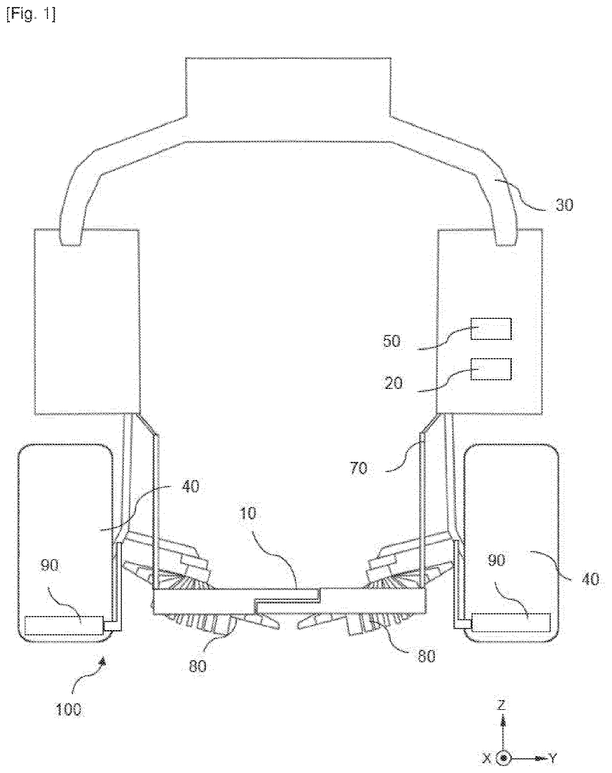

FIG. 1 schematically shows a non-limiting example of an autonomous agricultural robot 100. In the rest of the description, the terms “autonomous agricultural robot” or “robot” will be used interchangeably to refer to the autonomous agricultural robot 100.

Said robot conventionally comprises a straddle frame 30. The straddle frame 30 is configured to define a passageway for a row of crops or plantations.

The robot 100 further comprises means 40 for propelling it according to a direction of forward travel.

The autonomous agricultural robot 100 will be associated with an XYZ reference frame, called the robot reference frame. This robot reference frame has three orthonormal axes X, Y, Z. This robot reference frame is defined with respect to a relative position of the autonomous agricultural robot 100 under standard conditions of use, in particular when its propulsion means 40 are in contact with the ground.

Said robot reference frame includes:
an X axis, called the longitudinal axis, parallel to the direction of forward travel of the autonomous agricultural robot 100,
a Y axis, called the transverse axis, perpendicular to the longitudinal axis, and oriented in a horizontal direction when its propulsion means 40 are in contact with the ground,
a Z axis, called the vertical axis, perpendicular to the longitudinal axis and to the transverse axis, and oriented in a vertical direction.

The straddle frame 30 comprises a front portion, a rear portion and two lateral sides, called the first lateral side and the second lateral side. The front and rear portions are defined with respect to the direction of forward travel of the robot 100.

The propulsion means 40 of the robot are arranged at the two lateral sides of the straddle frame 30.

In the rest of the description, we will refer by:
length of the robot 100, its dimension according to the X axis,
width of the robot 100, its dimension according to the Y axis, and
height of the robot 100, its dimension according to the Z axis.

The size of the autonomous agricultural robot 100 refers to the overall height, width and length.

The robot 100 may have different sizes in order to adapt to different types of crops.

Thus, in the selected context, the width of the robot 100 is dimensioned so that the propulsion means 40 move on either side of a row of crops or plantations. The height of the robot 100 is dimensioned so that the straddle frame 30 straddles over the row of crops.

Advantageously, the propulsion means 40 enable the robot 100 to move forward, to turn, to make a half-turn. The propulsion means 40 are conventionally connected to the straddle frame 30 via trains, not shown herein.

In a preferred aspect, as illustrated in FIG. 1, the propulsion means 40 are formed by wheels. Preferably, the propulsion means 40 are formed by four wheels, two wheels arranged at each lateral side of the straddle frame 30. For each lateral side of said straddle frame, a wheel, called the front wheel, is located at the front portion of the straddle frame 30 and a wheel, called the rear wheel, is located at the rear portion of the straddle frame 30.

Preferably, the robot 100 includes a bumper 90 positioned upstream of each front wheel with respect to the direction of travel. Advantageously, the bumpers 90 allow protecting the robot by absorbing shocks when an obstacle lies in front of said front wheels. Preferably, the bumpers 90 are arranged at a low height with respect to the ground. In one aspect, the bumpers 90 are located about ten centimetres from the ground.

Preferably, the propulsion means 40 are associated with at least one motor which enables the robot 100 to move forward at a predefined speed and adapted in particular to the constraints of the terrain and the crop in which the robot 100 is moving. In one aspect, the maximum forward speed of the robot 100 is 6 km/h.

Preferably, the robot 100 includes an agricultural tool 80. Said agricultural tool allows performing crop maintenance operations. For example, this agricultural tool 80 may be a weeding, debudding, stripping or trimming tool.

In the non-limiting example of FIG. 1, the agricultural tool 80 is a weeding tool. It includes two weeding heads intended to stir up the soil on either side of the vine stocks.

Preferably, the agricultural tool 80 is positioned under the straddle frame 30, for example between the front wheels and the rear wheels in order to limit the size of the robot 100.

For example, said agricultural tool is connected to the straddle frame 30 via hooking means. Preferably, the hooking means are reversible, in order to be able to change agricultural tools easily.

The robot further comprises a control unit 50. In particular, this control unit 50 is configured to enable the robot 100 to operate autonomously.

Preferably, the control unit 50 is associated with the propulsion means 40, the bumpers 90, the engine, the agricultural tool 80.

For example, the control unit 50 is a computer, a mini-computer or any other computer element of the same type.

The control unit 50 enables an operator to program the robot 100, for example to make it move forward, manoeuver, stop according to a set of predefined conditions. In particular, said control unit is configured to control the propulsion means 40.

In a preferred aspect, the control unit 50 is programmed such that when a bumper encounters an obstacle, said control unit makes the robot 100 stop.

In one aspect, not shown in the figures, the robot 100 comprises a location system. Said location system allows locating the robot 100 in the environment in which it evolves.

The location system also allows producing a georeferenced cartography of the parcel in which it will evolve in order to carry out the autonomous guidance of the robot 100 in said parcel. For example, the location system is a satellite positioning system, such as the GPS system (acronym of Global Position System).

Preferably, the navigation system is connected to the control unit 50.

According to the disclosure, the robot 100 includes an obstacle characterisation device, also referred to as a “device” in the following description. The obstacle characterisation device is intended to enable the robot 100 to evolve in an even more autonomous and safe manner, in particular in an environment where obstacles, such as animals, could cross the trajectory of the robot 100.

This device comprises obstacle detection means 10 configured to detect an obstacle located on a trajectory of the robot 100. The obstacle detection means 10 are arranged on the robot 100 in order to detect an obstacle located in the passageway defined by the straddle frame, upstream or downstream of said passageway depending on the direction of forward travel of the robot.

When an agricultural tool is present on the robot 100, the obstacle detection means 10 are advantageously arranged, according to the direction of forward travel of the robot, upstream or at the front portion of the straddle frame 30, preferably upstream of the agricultural tool 80.

This device further comprises a processing unit 20.

In one aspect, said processing unit is configured, when an obstacle is detected by the obstacle detection means 10, to record the data detected by the obstacle detection means 10.

In another aspect, the processing unit 20 is configured, when an obstacle is detected by the obstacle detection means 10, to process the data detected by the obstacle detection means 10 and determine at least one characteristic of the detected obstacle.

In another aspect, said processing unit is configured, when an obstacle is detected by the obstacle detection means 10, to:
record the data collected by the obstacle detection means 10,
process the data detected by the obstacle detection means 10 and determine at least one characteristic of the detected obstacle.

In one aspect, a characteristic of the detected obstacle is the position of said detected obstacle with respect to the robot reference frame.

In another aspect, a characteristic of the detected obstacle is the apparent dimension of said detected obstacle.

In a non-limiting manner, the processing unit 20 comprises a computer.

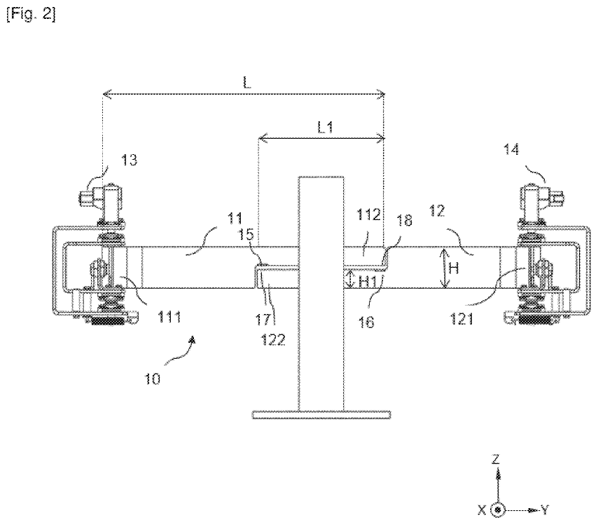

In a preferred aspect, as illustrated in FIGS. 1 and 2, the obstacle detection means 10 are mechanical detection means.

In other words, the obstacle detection means detect an obstacle when said obstacle comes into contact with all or part of the obstacle detection means.

For example, these obstacle detection means 10 include two arms, called first and second arms (11, 12), movable and arranged respectively on either side of a longitudinal midplane of the passageway defined by the straddle frame. It is clear that the longitudinal midplane is located in an XZ plane of the robot reference frame.

The two arms are arranged respectively at a lateral side of the straddle frame 30.

The first arm 11 has a first end 111 and an opposite second end 112. The second arm 12 has a first end 121 and an opposite second end 122.

In one aspect, each of said two arms is movably mounted, preferably at their first end, to a connection support 70. Preferably, said connection support is fixedly secured to the straddle frame 30 of the robot 100.

Preferably, the connection support 70 is made of a rigid material capable of holding the position of the two arms 11, 12.

Preferably, to reduce the weight of the robot 100, the connection support 70 is made up of hollow sections.

In one aspect which is not shown herein, the connection support 70 is telescopic. This aspect allows integrating the obstacle detection means 10 on robots 100 having a different width and/or height.

In the non-limiting aspect illustrated in FIG. 1, the connection support 70 comprises a first branch intended to connect the first arm 11 to the straddle frame 30 and a second branch intended to connect the second arm 12 to the straddle frame 30. In the non-limiting example, the first branch and the second branch are telescopic.

In a particular aspect wherein the robot 100 comprises bumpers 90, the two arms 11, 12 of the obstacle detection means 10 are advantageously arranged, according to the Z axis, above the bumpers 90. Advantageously, such positioning allows avoiding collisions between the two arms 11, 12 of the obstacle detection means 10 and the bumpers 90 when the robot 100 forms half-turn, a manoeuver during which the bumpers 90 are driven with the wheels.

In one aspect, the two arms 11, 12 of the obstacle detection means 10 are located at about thirty centimetres from the ground.

Preferably, to reduce the weight of the obstacle detection means 10, the two arms 11, 12 are hollow and/or made of composite material. Preferably, the two arms 11, 12 are not made of a metallic material.

In one aspect which is not shown herein, the two movable arms 11, 12 are telescopic. Advantageously, this aspect enables the obstacle detection means 10 to adapt to robots 100 having different widths.

When no pressure is exerted on the two arms 11, 12, it is said that two arms are in the rest position.

When an obstacle comes into contact with the two arms 11, 12, said two arms change position. The obstacle detection means 10 further include two sensors, one sensor per arm. Each sensor, called a position sensor, is configured to detect a change in the position of the associated arm. The first position sensor 13 will be called the sensor associated with the first arm 11 and the second position sensor 14, the sensor associated with the second arm 12.

The first position sensor 13 is configured to detect a change in the position of the first arm 11. The second position sensor 14 is configured to detect a change in the position of the second arm 12.

In a first mechanical configuration of the obstacle detection means, the two arms 11, 12 are movable in rotation, according to an axis parallel to the longitudinal midplane of the passageway.

Each arm 11, 12 opens in a direction opposite to the direction of forward travel of the robot 100. In other words, when an agricultural tool 80 is present on the robot 100, each arm opens towards the rear portion of the straddle frame 30, towards the agricultural tool 80. Preferably, each arm 11, 12 can move respectively between the rest position and a so-called maximum opening position.

Preferably, the two arms 11, 12 are identical in shape and length.

In an example of positioning of the two arms 11, 12, in the rest position, said two arms are arranged in two distinct planes YZ. Preferably, the two arms 11, 12 have lengths larger than half the distance between the first ends of each arm. Preferably, these two planes are close so that the two arms 11, 12 are substantially joined over a portion of their length, in the rest position.

In another aspect, in the rest position, the two arms 11, 12 are arranged in two planes not perpendicular to the longitudinal midplane of the passageway, symmetrical with respect to said longitudinal midplane. The two arms 11, 12 are dimensioned, in the rest position, so that the second ends of each arm are at equal distance from the longitudinal midplane of the passageway. Preferably, the second ends of each arm are located proximate to each other. In one aspect, the second ends of the two arms 11, 12 of the obstacle detection means 10 are spaced apart by a few millimetres, preferably less than 5 mm, in the rest position.

In another aspect, in the rest position, the two arms 11, 12 are arranged in the same YZ plane. The arms are dimensioned according to the Y axis in the rest position, so that the second ends of each arm face each other. The second ends of each arm are located proximate to each other. In one aspect, the second ends of the two arms 11, 12 of the obstacle detection means 10 are spaced apart by a few millimetres, preferably less than 5 mm, in the rest position.

In one aspect of the arms, each arm is for example in the form of a longitudinal bar. The longitudinal bar has a length L according to the X axis of the robot 100, a height H according to the Z axis of the robot 100 and a thickness e according to the Y axis of the robot 100.

In an improved aspect of the arms, and specific to the case where, in the rest position, the two arms 11, 12 are arranged in the same YZ plane, as illustrated in FIG. 2, each arm has, over a length L1 from its second end, a reduced height H1. The two arms 11, 12 are positioned so that, in the rest position, the reduced-height portions of each arm are superimposed on top of each other according to the Z axis. As illustrated in a non-limiting manner in FIG. 2, each arm 11, 12 has a length L. Each arm 11, 12 comprises two portions. A first portion has a length L1 which starts from the second end 112, 122 of each arm 11, 12. The first portion has a height H1, and is called a reduced-height portion. A second portion of each arm 11, 12 has a length equal to (L-L1) and a height H. The two portions have the same thickness e.

The length L of each arm 11, 12 is such that each arm 11, 12 extends beyond the longitudinal plane of the passageway.

Advantageously, this particular shape of the two arms 11, 12 allows on the one hand limiting the size and weight of the obstacle detection means 10 on the robot 100, and on the other hand accelerating the return of the two arms 11, 12 in the rest position.

This particular shape of the two arms 11, 12 enables said two arms to be superimposed on top each other at their reduced-height portions.

This aspect has the advantage of characterising the obstacles not comprised substantially at the longitudinal plane of the passageway in a more accurate manner compared to a configuration of the obstacle characterisation device having arms comprising no reduced-height portions superimposed on top of each other.

Advantageously, the length L1 is selected to allow accurately characterising off-centre obstacles, i.e. distant from the longitudinal plane of the passageway according to the Y axis by a maximum distance equal to L1 divided by two. Nevertheless, the larger the length L1, the longer the time required for obstacle detection.

In this first mechanical configuration of the obstacle detection means, the two position sensors 13, 14 are angular sensors. Preferably, the first angular sensor 13 is arranged at the first end 111 of the first arm 11. The first angular sensor 13 is configured to measure the angular displacement of the first arm 11 with respect to the rest position, i.e. the measurement of the angle α₁ that the first arm 11 forms with respect to the rest position. Thus, in a preferred aspect wherein the two arms 11, 12 are aligned according to the Y axis in the rest position, in a non-limiting manner, when the first arm 11 is in the rest position, the first angular sensor is configured to measure a zero angle α₁ and when the first arm is in the maximum open position, the first angular sensor is configured to measure an angle α₁ of 90°.

Similarly, the second angular sensor 14 is arranged at the first end 121 of the second arm 12. The second angular sensor 14 is configured to measure the angular displacement of the second arm 12 with respect to the rest position, i.e. the angle α₂ that the second arm 12 forms with respect to the rest position. Thus, in the aspect wherein the two arms 11, 12 are aligned according to the Y axis in the rest position, when the second arm 12 is in the rest position, the second angular sensor is configured to measure a zero angle α₂ and when the second arm 12 is in the maximum open position, the second angle sensor is configured to measure an angle α₂ of 90°.

In a second mechanical configuration (not shown in the figures) of the obstacle detection means, the two arms 11, 12 are movable in translation, in a plane other than the longitudinal midplane of the passageway. In a non-limiting manner, the two arms 11, 12 are able to slide linearly according to a direction of movement not aligned with the direction of forward travel.

Preferably, the two arms 11, 12 are mounted movable in translation according to the Y axis relative to the connection support 70. Each arm moves in a direction other than the direction of forward travel of the robot 100. Preferably, this direction is normal to the direction of forward travel. Each arm can move respectively between the rest position and a so-called maximum opening position, in which the arm is offset transversely towards the outside of the robot 100.

Preferably, the two arms 11, 12 are identical in shape and length.

In one aspect, in the rest position, the two arms 11, 12 are arranged in the same YZ plane. The arms are sized according to the Y axis in the rest position, so that the second ends of each arm face each other. The second ends of each arm are located proximate to each other. In one aspect, the second ends of the two arms 11, 12 of the obstacle detection means 10 are spaced apart by a few millimetres, preferably less than 5 mm, in the rest position.

In one aspect of the arms, each arm is for example in the form of a longitudinal bar. The longitudinal bar has a length L according to the X axis of the robot 100, a height H according to the Z axis of the robot 100 and a thickness e according to the Y axis of the robot 100.

In this second mechanical configuration of the obstacle detection means, the two position sensors are linear displacement sensors. Preferably, the first linear displacement sensor is arranged at the first end of the first arm. The first linear displacement sensor is configured to measure the linear displacement of the first arm 11 with respect to the rest position, i.e. the measurement of the angle CM that the first arm 11 forms with respect to the rest position. Thus, in a preferred aspect wherein the two arms 11, 12 are aligned according to the Y axis in the rest position, in a non-limiting manner, when the first arm 11 is in the rest position, the first angular sensor is configured to measure a zero displacement d₁ and when the first arm is in the intermediate open position, the first linear displacement sensor is configured to measure a positive displacement d₁. Similarly, the second linear displacement sensor is arranged at the first end 121 of the second arms 12. The second linear displacement sensor is configured to measure the displacement d₂ of the second arm 12 according to the Y axis. Thus, for example, when the second arm 12 is in the rest position, the second linear displacement sensor is configured to measure a zero displacement d₂ and when the second arm 12 is in an intermediate open position, the second linear displacement sensor is configured to measure a positive displacement d₂.

In a particularly advantageous aspect, regardless of the mechanical configuration of the obstacle detection means, said obstacle detection means include a validation unit configured to validate the proper positioning of the two arms 11, 12, when said two arms are in the rest position. Advantageously, such a validation unit allows ensuring that one of the two arms 11 or 12 or both arms 11, 12 are not deformed.

In a preferred aspect wherein the two arms 11, 12 are aligned according to the Y axis in the rest position, illustrated in particular in FIG. 2 for the first mechanical configuration of the obstacle detection means, this validation unit is formed by two proximity sensors. More specifically, a first proximity sensor 15 is positioned at the second end 112 of the first arm 11 and oriented towards the second end 122 of the second arm 12. A second sensor 16 is positioned at the second end 122 of the second arm 12 and oriented towards the second end 112 of the first arm 11.

In this preferred aspect, the fact that the two arms 11, 12 are positioned so that, in the rest position, the reduced-height portions of each arm are superimposed on top each other, allows guaranteeing more accurately that the two arms are well positioned with respect to each other and that there is no deformation of one or both arms, or that one of the two arms has broken.

In a preferred aspect, the first and second proximity sensors 15 and 16 are inductive proximity sensors.

In such an example, the two arms 11, 12 are preferably made of a material other than a metallic material.

The first proximity sensor, inductive, is associated with an additional element, electrically conductive, fastened on the second arm 12. In the absence of deformation of one or both arms 11, 12, the first proximity sensor 15 and the associated additional element 17 are arranged opposite one another, when the two arms 11, 12 are in the rest position.

Similarly, the second proximity sensor 16, inductive, is associated with an additional element 18, electrically conductive, fastened on the first arm 11. In the absence of deformation of one or both arms 11, 12, the second proximity sensor and the associated additional element are arranged opposite one another, when the two arms 11, 12 are in the rest position.

Preferably, the validation unit, in other words the first and second proximity sensors 15, 16, is connected to the control unit 50.

The data transmitted by the first and second proximity sensors 15 and 16 may be transmitted by any known signal transmission means, whether wired or not.

In the case of wired transmission by cables, and when the first and second arms 11 and 12 are made up of hollow sections, said cables are advantageously passed inside said hollow sections.

The control unit 50 is configured to verify that, when the data measured by the first and second position sensors 13, 14 are simultaneously zero, and therefore representative of the positioning of the two arms 11, 12 in the rest position, the data measured by the first and second proximity sensors 15 and 16 are representative of the positioning opposite the second ends of the two arms 11, 12.

In one aspect (not shown in the figures), regardless of the mechanical configuration of the obstacle detection means, said obstacle detection means include a system for returning the two arms 11, 12 to the rest position. This return system may be active or passive.

In a preferred aspect, the return system includes one return member per arm. In other words, the return system includes a first return member for the first arm and a second return member for the second arm.

Each return member is configured to generate a biasing force of the associated arm. Each return member is configured to bring the associated arm back towards the rest position when the force that moved said arm towards an intermediate position is suppressed.

In one aspect, each return member is a return spring. For example, it consists of a tension spring. In another aspect, it consists of a compression spring.

In an improved aspect, the first position sensor 13 may be replaced by two redundant first position sensors, arranged to measure the same value, and thus allowing improving the operating safety of the robot 100 in the event of failure of one of the two position sensors. Similarly, the second position sensor 14 may be replaced by two redundant second position sensors arranged to measure the same value.

As described before, the obstacle characterisation device includes a processing unit configured in particular to process the data detected by the obstacle detection means 10 and to determine at least one characteristic of the detected obstacle.

For example, the processing unit 20 may determine a position of the detected obstacle with respect to the reference frame of the robot 100 and/or an apparent dimension of the detected obstacle. By apparent dimension of the detected obstacle, it should be understood, for the mechanical version of the obstacle detection means, the spacing of the two second ends of the two arms 11, 12 when passing an obstacle.

The processing unit 20 may also determine, for the first mechanical configuration of the obstacle detection means, the sum of the angles of the two arms 11, 12, or, for the second mechanical configuration of the obstacle detection means, the sum of the displacements of the two arms 11, 12.

The processing unit 20 may be configured to verify whether the at least one characteristic meets a predefined criterion. In this case, the control unit 50 may be configured to generate a stop command to the robot 100 when at least one characteristic of the detected obstacle does not meet the predefined criterion. The robot 100 has been described in a preferred version in which the obstacle detection means are mechanical detection means. It is also possible to consider, without departing from the scope of the disclosure, making a robot 100 wherein the obstacle detection means are optical detection means.

In an aspect of the optical detection means, said optical detection means comprise two optical sets each including a laser emitter and a laser receiver. The laser emitter of a first optical set is arranged at the first lateral side of the straddle frame and is oriented towards the second lateral side. The laser receiver of the first optical set is positioned at the second lateral side of the straddle frame 30, opposite the laser emitter, so as to detect a light beam emitted by the associated laser emitter when no obstacle cuts the light beam. The laser emitter of a second optical set is arranged at the second lateral side of the straddle frame, proximate to the laser receiver of the first optical set, and oriented towards the first lateral side. The laser receiver of the second optical set is positioned at the first lateral side of the straddle frame, proximate to the laser emitter of the first optical set, so as to detect a light beam emitted by the associated laser emitter of the second assembly, when no obstacle cuts said light beam.

In this optical version of the obstacle detection means 10, the associated processing unit 20 is configured to determine at least one characteristic of the detected obstacle such as an apparent dimension of the detected obstacle and/or a position of the detected obstacle with respect to the reference frame of the robot 100. The determination of these characteristics is within the reach of a person skilled in the art and will not be described explicitly.

An example of a method for safeguarding the robot 100 is now described. Preferably, said safeguarding method is carried out for the previously-described robot 100, in at least one of its aspects, regardless of the version (optical or mechanical) of the obstacle detection means and regardless of the configuration of the mechanical version of the obstacle detection means. In our non-limiting example of application, the robot 100 is preferably in operation and evolves according to a programmed trajectory.

The safeguarding method is described, in a non-limiting manner, in the case where the obstacle detection means are mechanical.

The method for safeguarding the robot 100 is intended to enable said robot 100 to evolve safely in its environment, by characterising the elements of its environment which may form a disturbing obstacle for the proper operation of the robot 100. Advantageously, the method for safeguarding the robot allows making the robot 100 stop if an element in its trajectory actually forms a disturbing obstacle.

A first step in the method for safeguarding the robot 100 consists in obtaining the data detected by the obstacle detection means 10.

In one example of implementation, said read data are the data measured by the first position sensor and those measured by the second position sensor.

Preferably, the data are obtained simultaneously by the first position sensor and the second position sensor.

Afterwards, the obstacle detection means 10 transmit the data to the processing unit 20. The transmission may be performed via any link type, wired or not.

In one example of implementation, the transmission is performed via a wired connection, via the cables arranged in the hollow sections of the connection support 70.

The data may be recorded and stored in an allocated memory space in the processing unit 20.

In a second step, the processing unit 20 processes the received data and determines at least one of the characteristics of the detected obstacle.

As a reminder, a characteristic of the detected obstacle may be a position of the detected obstacle with respect to the robot reference frame, or an apparent dimension of the detected obstacle.

When the robot is made with the first mechanical configuration of the obstacle detection means, a characteristic of the detected obstacle may be the sum of the angles of the two arms 11, 12. When the robot is made with the second mechanical configuration of the obstacle detection means, a characteristic of the detected obstacle may be the sum of the displacements of the two arms 11, 12.

In one mode of implementation, when the at least one characteristic is the apparent dimension of the detected obstacle or the position of the obstacle, the processing unit determines the dimension of the obstacle or the position of the obstacle from trigonometric calculations. Such trigonometric calculations are within the reach of a person skilled in the art and will not be described explicitly.

In a third step, the processing unit 20 verifies whether the at least one characteristic of the detected obstacle meets a predefined criterion.

In one mode of implementation, this predefined criterion is selected beforehand by an operator of the robot 100. Afterwards, the operator integrates it into the control unit 50. The predefined criterion depends on the characteristic of the detected obstacle.

In one example of implementation, when the characteristic of the detected obstacle is a position of the detected obstacle, the predefined criterion is met when the calculated position does not exceed a predefined value. For example, this predefined value may correspond to a maximum positioning authorised for the obstacle. Preferably, the predefined value would be a maximum lateral offset of a vine stock with respect to an average alignment of a row of vine stocks. Thus, the processing unit compares the calculated position with the predefined value.

In another example of implementation, when the characteristic of the detected obstacle is an apparent dimension of the detected obstacle, the predefined criterion is met when the calculated apparent dimension does not exceed a predefined value. Preferably, this predefined value corresponds to a maximum apparent dimension authorised for the obstacle. Thus, in a preferred case, the predefined value would be a maximum diameter of a vine stock. Henceforth, the method allows distinguishing, in this preferred yet non-limiting case of application, a vine stock to be treated from an obstacle whose apparent dimension would be larger than the diameter of the vine stock. Thus, the processing unit compares the calculated dimension with the predefined value.

In another example of implementation, when the characteristic of the detected obstacle is the sum of the angles of the two arms 11, 12 or a sum of the displacements of the two arms 11, 12, the predefined criterion is met when the calculated sum of the angles (or displacements) of the two arms 11, 12 does not exceed a predefined value. This predefined value corresponds to the sum of the angles that the two arms 11, 12 would take for an obstacle with an authorised maximum diameter, when said obstacle hits and moves the two arms 11, 12. In an example of implementation, the authorised maximum diameter corresponds to that of a vine stock of the treated vine parcel. Thus, the processing unit 20 compares the calculated sum with the predefined value.

In a fourth step, the processing unit 20 transmits to the control unit 50 of the robot 100 an instruction to stop the robot 100 when the at least one characteristic does not meet the predefined criterion.

In one example of implementation, the stop instruction is transmitted to the motor of the robot 100 which shuts down.

This transmission may be performed via any link type, wired or not. A message may also be sent to the operator.

For example, in a preferred aspect of the second version of the obstacle detection means 10, when the sum of the angles of the two arms 11, 12 exceeds the authorised maximum sum of the angles of the two arms 11, 12, the processing unit 20 transmits to the control unit 50 of the robot 100 an instruction to stop the robot 100. In the preferred case, the maximum sum corresponds to a maximum spacing of the two arms 11, 12 corresponding to the maximum diameter of a vine stock. Thus, when the obstacle detection means 10 encounter an obstacle whose apparent dimension is larger than the maximum diameter of a vine stock, the processing unit 20 transmits, to the control unit 50 of the robot 100, an instruction to stop robot 100.

Advantageously, this operation allows making the robot 100 stop autonomously only when the obstacle detection means 10 encounter an undesired obstacle, i.e. with an apparent dimension larger than the diameter of a vine stock.

The obstacle detection means 10 characterise more accurately the encountered obstacles when they generate the simultaneous movement of the two arms 11, 12 rather than a single arm 11 or 12. Indeed, the same movement of an arm 11 or 12 may be generated by an obstacle, with an apparent width a, positioned at a distance b from the longitudinal plane of the passageway, or by an obstacle, with an apparent width (a+b/2), positioned at a distance b/2 from the longitudinal plane of the passageway.

Thus, a vine stock positioned at a given distance from the longitudinal plane of the passageway so as to be detected by only one arm could be considered as a false positive, in other words, considered as an obstacle whose apparent dimension would be larger than the detection threshold while said apparent dimension would be artificially increased due to the distance of the obstacle from the longitudinal plane of the passageway.

The configuration of the obstacle detection means shown in FIGS. 1 and 2 having two movably mounted arms with the shape enabling said two arms 11, 12 to be superimposed on top each other at their reduced-height portions thus allows reducing the detection of false positives. Hence, it offers a more accurate characterisation of the obstacles distant from the longitudinal plane of the passageway.

The first, second and third steps are repeated sequentially, iteratively, as long as the robot 100 does not receive a stop instruction.

The first and second position sensors of the obstacle detection means 10 may perform measurements continuously, as soon as the robot 100 is running and moving forward. Alternatively, the first and second position sensors perform measurements continuously, only when an agricultural tool 80 is present on the robot 100.

Preferably, the data collected by the first and second position sensors are taken at regular time intervals that are short enough to quickly detect the variation in the angles α₁, α₂ or the variation in the displacements d₁, d₂, depending on the mechanical configuration of the detection means d obstacles 10. For example, the data are collected, by each position sensor, at time intervals in the range of a few tenths of a second.

Thus, as long as no obstacle hits one of the two arms 11, 12, the robot 100 continues to move forward. As soon as an obstacle hits one of the two arms 11, 12:
if the characteristic of the selected and determined obstacle meets the associated predefined criterion, the robot 100 continues to move forward,
if the characteristic of the selected and determined obstacle does not meet the associated predefined criterion, the robot 100 is stopped.

Thus, the method allows distinguishing between the object to be processed, in the example the vine stock, and the other elements of the environment which may form an obstacle located in the trajectory of the robot 100 and which may affect the proper operation of the robot 100. The method, associated with the obstacle characterisation device, improves the autonomy of the robot 100 and allows limiting the intervention of an operator during the vine maintenance operation.

When the robot 100 is stopped, following the detection of an obstacle, an information message may be transmitted by the control unit 50 to an operator in order to warn him. Once the obstacle has been suppressed by the operator, the robot 100 can restart, as well as the method.

In a particular mode of implementation, when the obstacle detection means 10 include a validation unit, the method includes:
a step of measuring, by the first proximity sensor 15, a value representative of the positioning of the first arm 11 with respect to the second arm 12,
a step of measuring, by the second proximity sensor 16, a value representative of the positioning of the second arm 12 with respect to the first arm 11,
a step of validating the proper positioning of the two arms 11, 12 in the rest position.

Said measurement and validation steps are repeated sequentially, iteratively, as long as the robot 100 does not receive a stop instruction.

The first and second proximity sensors 15 and 16 may perform their measurements continuously, as soon as the robot 100 is running and moving forward. Alternatively, the first and second proximity sensors 15 and 16 perform measurements continuously, only when the values measured by the first and second position sensors are simultaneously zero.

Preferably, the measurements performed by the first and second proximity sensors are performed at the same regular time intervals as for the first and second position sensors.

The validation step consists in verifying that, when the values measured by the first and second position sensors 13, 14 are simultaneously zero, the values measured by the first and second proximity sensors 15 and 16 are actually representative of the positioning of the two arms 11, 12 at rest.

The robot 100 is then also stopped when the verification shows an inconsistency between the measured values of the first and second position sensors and the measured values of the first and second proximity sensors 15, 16.

In one example of implementation, a robot stop instruction 20 is generated by the control means 50. An information message may be transmitted to the operator.

In this particular mode of implementation, the method allows alerting the operator to a possible malfunction of the device, such as for example a misalignment of at least one of the two position sensors, or a deformation of at least one of the two arms 11, 12.

In a particular mode of implementation, the safeguarding method may include a prior step of producing a georeferenced cartography of a crop parcel with a location of the acceptable obstacles.

In an example of implementation of this prior step, said prior step is carried out during a georeferenced cartography in order to carry out the autonomous guidance of the robot 100 in said crop parcel.

Besides the spatial coordinates of the vine stocks, the spatial coordinates of the obstacles other than the vine stocks, but which are considered not disturbing the operation of the robot, are recorded and stored in the memory space of the control unit 50. For example, these spatial coordinates are stored in the form of a list, called an exception list.

In this particular mode of implementation, the stoppage of the robot 100 is then conditioned on the additional verification that the detected obstacle is not part of the acceptable obstacles.

In other words, when the at least one characteristic of the detected obstacle does not meet the predefined criterion, the spatial coordinates of the obstacle are compared with the spatial coordinates of the acceptable obstacles of the exception list.

For example, the spatial coordinates of the obstacle are obtained from the location system of the robot 100 and are transmitted to the control unit 50 which compares them with the spatial coordinates of the acceptable obstacles of the exception list.

If the detected obstacle is part of the exception list, the robot 100 continues to move forward.

If the obstacle is not part of the exception list, the robot 100 is stopped.

Thus, such a method, associated with the obstacle characterisation device, considerably improves the autonomy of the robot 100 by limiting the intervention of an operator during the vine maintenance operation.

Advantageously, this method allows limiting false positives, i.e. stops of the robot 100 that would not be due to a disturbing obstacle located in the trajectory of said robot.

Advantageously, the robot 100, associated with the obstacle characterisation device, may also be used to produce a cartography of a crop parcel. Advantageously, the robot includes a location system.

The method for producing a cartography of a crop parcel by means of the robot 100 includes, when an obstacle is detected by the obstacle detection means 10, the following steps.

A first step consists in obtaining the data collected by said obstacle detection means.

In one example of implementation, said collected data are the data measured by the first position sensor and those measured by the second position sensor.

Preferably, the data are obtained simultaneously by the first position sensor and the second position sensor.

Afterwards, the obstacle detection means 10 transmit the data to the processing unit 20. The transmission may be carried out via any link type, wired or not.

The processing unit may transmit the data to the control unit 50.

In a second step, a collection of the location of the robot 100 is performed by the navigation system.

Preferably, the collection of the location of the robot is carried out simultaneously with the obtainment of the data by the obstacle detection means.

Afterwards, the navigation system transmits the collected location of the robot to the control unit 50.

In a third step, the data collected by the obstacle detection means and the collected location of the robot are recorded in the form of a doublet.

Preferably, the doublet is stored in the control unit 50.

The doublet may also be stored in an allocated memory space in the control unit 50.

Next, said doublet may also be transmitted to a system external to the robot 100 in order to be further processed.

In a particular aspect of the method for producing a cartography of a crop parcel, following the step of obtaining the data detected by the obstacle detection means 10, the processing unit may process the data and determine at least one characteristic of the detected obstacle. The processing unit 20 transmits said at least one characteristic of the detected obstacle to the control unit 50. The control unit 50 then records a “the at least one characteristic of the detected obstacle—location of the robot 100” doublet. Next, said doublet may be transmitted to a system external to the robot 100 in order to be further processed. In a preferred aspect, in the context of a vineyard, all of said doublets allow highlighting the vines and their respective locations and may form a prior cartography without requiring additional processing with an external system. In addition, the spatial coordinates of the obstacles other than the vines, but which are considered not disturbing the operation of the robot, are recorded and stored in the memory space of the control unit 50.

In a particular mode of implementation of the method for producing a cartography of a crop parcel, and when the obstacle detection means of the robot 100 comprise a validation unit, the method includes:
a step of measuring, by the first and second proximity sensors 15, 16, a value representative of the positioning of the first arm 11 with respect to the second arm 12,
a step of validating the proper positioning of the two arms 11, 12 in the rest position.

The first and second proximity sensors 15 and 16 may perform their measurements continuously, as soon as the robot 100 is running and moving forward.

Alternatively, the first and second proximity sensors 15 and 16 perform measurements continuously, only when the values measured by the first and second position sensors are simultaneously zero.

Preferably, the measurements performed by the first and second proximity sensors are performed at the same regular time intervals as for the first and second position sensors.

The validation step consists in verifying that, when the values measured by the first and second position sensors 13, 14 are simultaneously zero, the values measured by the first and second proximity sensors 15 and 16 are actually representative of the positioning of the two arms 11, 12 at rest.

An instruction to stop the robot 100 may be transmitted when the verification shows an inconsistency between the measured values of the first and second position sensors and the measured values of the first and second proximity sensors 15, 16.

In one example of implementation, a robot stop instruction 20 is generated by the control means 50. An information message may be transmitted to the operator. This method allows alerting the operator on a possible malfunction of the device, which might distort the cartography being produced.

It clearly arises from the present description that some components of the robot 100, of the safeguarding method, and of the method for producing a cartography could be modified and that some adjustments could be made, yet without departing from the scope of the disclosure defined by the claims.

It goes without saying that the present disclosure is not limited to the aspects that have just been described and that various modifications and simple variants may be considered by a person skilled in the art without departing from the scope of the disclosure as defined by the appended claims.

What is claimed is:

1. An autonomous agricultural robot, said robot, including:
a straddle frame defining a passageway for a row of crops,
propulsion means of the robot in a direction of forward travel,
a control unit of the robot,
characterised in that the autonomous agricultural robot includes an obstacle characterisation device including:
obstacle detection means configured to detect an obstacle located on a path of the autonomous agricultural robot,
a processing unit configured, when an obstacle is detected by the obstacle detection means, to:
record the data collected by said obstacle detection means, and/or
process the data collected by said obstacle detection means and determine at least one characteristic of the detected obstacle.

2. The autonomous agricultural robot according to claim 1, wherein the processing unit is configured to verify whether the at least one characteristic meets a predefined criterion.

3. The autonomous agricultural robot according to claim 1, wherein the obstacle detection means include:
two arms, movable and arranged respectively on either side of a longitudinal midplane of the passageway, and
two sensors, one sensor per arm, each sensor being configured to detect a change in the position of the associated arm.

4. The autonomous agricultural robot according to claim 3, wherein:
the two arms are movable in rotation, according to an axis parallel to the longitudinal midplane of the passageway,
the two sensors are angular sensors.

5. The autonomous agricultural robot according to claim 4, wherein, when the two arms are in the so-called rest position, i.e. when no pressure is exerted on the two arms, said two arms are arranged in the same plane transverse to the direction of forward travel, said arms comprising a first and a second arm, the first arm comprising a first end and a second opposite end, the second arm comprising a first end and a second opposite end, the second ends of each arm being positioned opposite one another.

6. The autonomous agricultural robot according to claim 5, wherein said two arms are in the form of a longitudinal bar, and in which, when the arms are in the rest position, each arm has:
a length according to a longitudinal axis parallel to the direction of forward travel of the robot,
a height according to a vertical axis, perpendicular to the longitudinal axis and to a transverse axis, itself perpendicular to the longitudinal axis, and oriented in a horizontal direction when the propulsion means 40 of the robot are in contact with the ground,
each arm having over a length from the second end a reduced height, such that, in the rest position, the reduced-height portions of each arm are superimposed on top of each other.

7. The autonomous agricultural robot according to claim 3, wherein:
the two arms are movable in translation, in a plane perpendicular to the longitudinal midplane of the passageway,
the two sensors are linear displacement sensors.

8. The autonomous agricultural robot according to claim 1, wherein the at least one characteristic of the detected obstacle is selected from:
a position of the detected obstacle with respect to a reference frame of the robot,
an apparent dimension of the detected obstacle.

9. The autonomous agricultural robot according to claim 4, wherein the at least one characteristic of the detected obstacle is selected from:
a position of the detected obstacle with respect to a reference frame of the robot,
an apparent dimension of the detected obstacle,
the sum of the angles of the two arms or a sum of the displacements of the two arms.

10. A method for safeguarding an autonomous agricultural robot in accordance with claim 2 including, when an obstacle is detected by the obstacle detection means, the steps of:
Obtaining the data collected by the obstacle detection means,
Processing the data and determining at least one characteristic of the detected obstacle, by the processing unit,
Verifying, by the processing unit, whether the at least one characteristic of the detected obstacle meets the predefined criterion,
Transmitting, to the control unit of the robot, an instruction to stop the robot when the at least one characteristic does not meet the predefined criterion.

11. The safeguarding method according to claim 10, wherein, when the at least one characteristic is the apparent dimension of the detected obstacle, the processing step includes the calculation of the apparent dimension of the detected obstacle, the predefined criterion being met when the calculated apparent dimension does not exceed a predefined value.

12. The safeguarding method according to claim 10, wherein, when the at least one characteristic is the position of the detected obstacle, the processing step includes the calculation of the position of the obstacle, the predefined criterion being met when the calculated obstacle position does not exceed a predefined value.

13. The safeguarding method according to claim 10, and when the autonomous agricultural robot includes:
a straddle frame defining a passageway for a row of crops,
propulsion means of the robot in a direction of forward travel,
a control unit of the robot,
characterised in that the autonomous agricultural robot includes an obstacle characterisation device including:
obstacle detection means configured to detect an obstacle located on a path of the autonomous agricultural robot,
a processing unit configured, when an obstacle is detected by the obstacle detection means, to:
record the data collected by said obstacle detection means, and/or
process the data collected by said obstacle detection means and determine at least one characteristic of the detected obstacle,
wherein the obstacle detection means include:
two arms, movable and arranged respectively on either side of a longitudinal midplane of the passageway, and two sensors, one sensor per arm, each sensor being configured to detect a change in the position of the associated arm, and
wherein:
the two arms are movable in rotation, according to an axis parallel to the longitudinal midplane of the passageway, and the two sensors are angular sensors, or
the two arms are movable in translation, in a plane perpendicular to the longitudinal midplane of the passageway, and the two sensors are linear displacement sensors.
wherein, when the at least one characteristic is the sum of the angles of the two arms or the sum of the displacements of the two arms, the processing step includes the calculation of the sum of the angles of the two arms or the sum of the displacements of the two arms, the predefined criterion being met when the calculated sum of the angles of the two arms or the calculated sum of the displacements of the two arms does not exceed a predefined value.

14. The safeguarding method according to claim 10, including a prior step of producing a georeferenced cartography of a crop parcel with a location of the acceptable obstacles.

15. The safeguarding method according to claim 14, the step of transmitting an instruction to stop the robot is conditional on additional verification that the detected obstacle is not part of the acceptable obstacles.

16. A method for producing a cartography of a crop parcel implemented by an autonomous agricultural robot in accordance with claim 1, the autonomous agricultural robot including a navigation system, said method including, when an obstacle is detected by the obstacle detection means, the steps of:
Obtaining data collected by said obstacle detection means,
Collecting the location of the autonomous agricultural robot (100) by the navigation system,
Recording of a “data detected by said obstacle detection means location of the autonomous agricultural robot” doublet.

17. The method for producing a cartography of a crop parcel implemented by an autonomous agricultural robot in accordance with claim 1, the autonomous agricultural robot including a navigation system, said method including, when an obstacle is detected by the obstacle detection means, the steps of:
Obtaining data collected by said obstacle detection means,
Collecting the location of the autonomous agricultural robot by the navigation system,
Processing the data collected by the obstacle detection means (10) and determining at least one characteristic of the detected obstacle,
Recording a “the at least one characteristic of the detected obstacle—location of the autonomous agricultural robot” doublet.
